(19) United States
(12) Patent Application Publication
(10) Pub. No.: US 2025/0284952 A1
(43) Pub. Date: Sep. 11, 2025

(54) PROCESSING METHOD AND DEVICE FOR FLOATING-POINT NUMBERS, NEURAL NETWORK TRAINING METHOD, AND FLOATING POINT NUMBERS DATABASE CONVERSION METHOD

(71) Applicant: MACRONIX INTERNATIONAL CO., LTD., Hsinchu (TW)

(72) Inventor: Shih-Hung CHEN, HsinChu County (TW)

(21) Appl. No.: 18/596,733

(22) Filed: Mar. 6, 2024

(51) Int. Cl. G06N 3/08; G06F 7/499

(52) U.S. Cl. CPC G06N 3/08; G06F 7/49915

(57) ABSTRACT

The application discloses a processing method and device for floating-point numbers, a neural network (NN) training method, and a floating-point number database conversion method. A custom floating-point number is acquired, wherein the custom floating-point number includes a sign field and an exponent field, and a numerical value of the custom floating-point number is determined by the sign field, the exponent field, a base value, and a bias value, where the base value is a non-integer value greater than 1 and less than 2. The custom floating-point number is applied in numerical calculations.

### TECHNICAL FIELD

The disclosure relates in general to a processing method and device for floating-point numbers, a neural network (NN) training method, and a floating-point number database conversion method.

### BACKGROUND

Floating Point is a data type used in computer science to represent numbers with decimal points. This representation method has a certain floating precision, allowing the representation of extremely large or small numbers and handling a certain level of decimal precision.

Here are some reasons for using floating-point numbers:

Real Number Processing: Floating-point numbers allow computer systems to effectively process real numbers, including decimals. This is crucial for calculations in fields such as science, engineering, and finance.

Range: Floating-point numbers can represent very large or very small numbers, which is not easily achievable with integer types. For example, in astronomy, representing the mass or distance of celestial bodies may require using extremely large numbers.

Precision: Floating-point numbers have a certain precision, allowing the representation of decimal parts. This is necessary for applications that require high-precision calculations, such as scientific computing.

Mathematical Operations: Floating-point numbers support various mathematical operations, including addition, subtraction, multiplication, and division, enabling computers to perform complex mathematical calculations.

However, floating-point numbers also have some issues, such as precision loss and rounding errors, which may lead to inaccurate calculation results in certain situations. Therefore, careful usage of floating-point numbers is required, especially in applications demanding high precision.

FP64 (64-bit floating-point), FP32 (32-bit floating-point), and FP16 (16-bit floating-point) are typical floating-point systems. These systems are versatile but have drawbacks such as suboptimal optimization and additional energy consumption, resulting in poorer performance. Currently, FP32 is the most widely used format.

For emerging artificial intelligence (AI) demands, the industry has proposed custom new floating-point formats, offering benefits such as reduced computational unit size and accelerated operations. However, these custom formats have fewer precision bits, leading to resolution loss issues.

In traditional floating-point numbers, the base value is typically 2, with the exponent bits responsible for doubling the space. The exponent bits control the numerical range, which is 2\hat{ }E, where E represents the number of exponent bits. The mantissa bits are responsible for linearly dividing the doubled space (for example, 1-2, 2-4, 4-8 etc) into 2\hat{ }M segments, where M represents the number of mantissa bits. However, the physical size of traditional floating-point hardware multipliers increases with the square of the number of mantissa bits.

Therefore, there is a current need for a method and device for processing floating-point numbers, as well as a method for neural network training and floating-point numbers database conversion, to improve the deficiencies of current floating-point systems.

### SUMMARY

According to one embodiment, a method for processing floating-point numbers applied to an electronic device is provided. The method comprises: acquiring a custom floating-point number, wherein the custom floating-point number includes a sign field and an exponent field, and a numerical value of the custom floating-point number is determined by the sign field, the exponent field, a base value, and a bias value, where the base value is a non-integer value greater than 1 and less than 2; and applying the custom floating-point number in numerical calculations.

According to another embodiment, provided is a floating-point processing device comprising a processor, the processor performing: acquiring a custom floating-point number, wherein the custom floating-point number includes a sign field and an exponent field, and a numerical value of the custom floating-point number is determined by the sign field, the exponent field, a base value, and a bias value, where the base value is a non-integer value greater than 1 and less than 2; and applying the custom floating-point number in numerical calculations.

According to an alternative embodiment, a method for converting a floating-point database applied to an electronic device is provided. The floating-point database conversion method comprises: extracting a plurality of test data from a first floating-point database and setting a test target, where values in the first floating-point database are in a first floating-point format; analyzing a numerical value range of the first floating-point database; based on the numerical value range of the first floating-point database and a calculation requirement, setting a plurality of parameters for a second floating-point format; converting the plurality of test data in the first floating-point format into a plurality of converted data in the second floating-point format, and checking whether the test target is achieved; and when the test target is achieved, converting the first floating-point database into a second floating-point database based on the plurality of parameters of the second floating-point format, where values in the second floating-point database are in the second floating-point format.

According to an alternative embodiment, a neural network training method applied to an electronic device is provided. The neural network training method comprises: receiving a plurality of input data; setting a plurality of parameters of a custom floating-point number format; and converting the input data into a plurality of converted data in accordance with the custom floating-point number format, and training a plurality of weight values, where the weight values conform to the custom floating-point number format, to find and store optimized parameters of the custom floating-point number format.

### BRIEF DESCRIPTION OF THE DRAWINGS

FIG. 1 illustrates a custom floating-point (MP) format in one embodiment of the present disclosure.

FIG. 2 illustrates some examples of the custom floating-point (MP 16) format according to one embodiment of the present disclosure.

FIG. 3 presents a practical example of the custom floating-point (MP16) format according to one embodiment of the present disclosure.

FIG. 4 illustrates the custom floating-point (MP) format according to one embodiment of the present disclosure.

FIG. 5 illustrates some examples of the custom floating-point MP32 according to an embodiment of the present invention.

FIG. 6A and FIG. 6B illustrate how the bias value Bias is set in the floating-point number MP system of this embodiment.

FIG. 7 illustrates the method of converting a floating-point number database according to an embodiment of the present disclosure, applied to an electronic device.

FIG. 8A and FIG. 8B figures depict MP data processing according to an embodiment of the present disclosure.

FIG. 9 illustrates a neural network training method according to an embodiment of the present disclosure, applied to an electronic device.

FIG. 10A presents experimental results comparing the custom floating-point MP format of an embodiment with other existing non-MP formats.

FIG. 10B compares the numerical range of the custom floating-point MP format of an embodiment with other known floating-point formats BF16 and FP16.

FIG. 11 illustrates an example of a neural network processing system 1100 according to an embodiment of the present disclosure.

FIG. 12 provides a schematic diagram of a system architecture according to an embodiment of the present disclosure.

FIG. 13 is a structural schematic diagram of an electronic device in an embodiment.

FIG. 14 illustrates a method for floating-point processing according to an embodiment, applied to an electronic device.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DESCRIPTION OF THE EMBODIMENTS

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

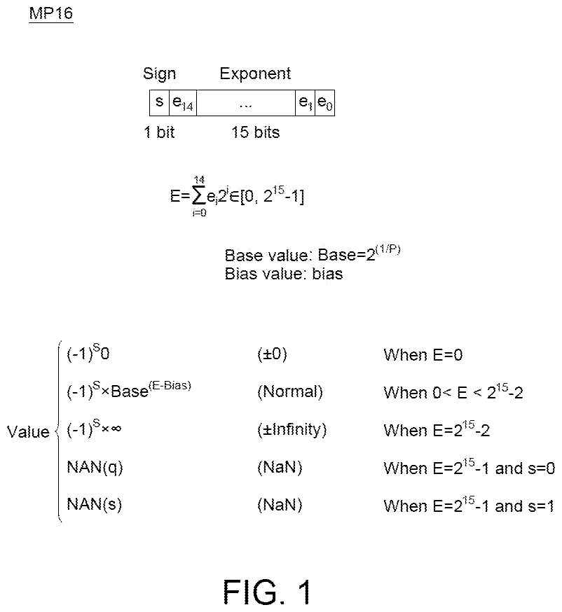

FIG. 1 illustrates a custom floating-point (MP) format in one embodiment of the present disclosure. The description will focus on a 16-bit custom floating-point (MP) format, referred to as MP16, as an example. However, it should be noted that the present disclosure is not limited to this specific format.

The 16-bit custom floating-point (MP16) format comprises a sign field (including a 1-bit sign bit “s”) and an exponent field (including 15 bits denoted as e₁₄ to e₀).

The 15-bit exponent field, represented in decimal as E (the numerical value of the exponent bits, also known as the value of the exponent field), is expressed by the following equation (1):

$$E = {\sum }_{0}^{14} {e}_{i} {2}^{i} ∈ [ 0 , {2}^{15} - 1 ] . \qquad ( 1 )$$

Therefore, the value of MP16 is as follows:

When E=0, MP16 is given by (−1)^{s}0. In this case, when s=0, MP16 is +0, and when s=1, MP16 is −0. Thus, when E=0, MP16 is referred to as positive-negative zero (±0). E=0 indicates that all exponent bits in the exponent field are set to 0.

When 0<E<2\hat{ }15−2, MP16 is given by MP16=(−1)^{s}×Base^{(E-Bias)},

referred to as a normal value.

When E=2\hat{ }15−2, MP16 is given by MP16=(−1)^{s}×∞, referred to as positive-negative infinity (±∞).

When E=2\hat{ }15−1 and s=0, MP16 is Not a number (NAN) (q), denoted as NaN (q).

When E=2\hat{ }15−1 and s=1, MP16 is NAN(s).

In summary:

$$Value = \{ \begin{matrix}{( - 1 )}^{s} 0 ( \pm 0 ) when E = 0 \\ {( - 1 )}^{s} \times {Base}^{( E - Bias )} ( normal ) when 0 < E < {2}^{15} - 2 \\ {( - 1 )}^{s} ∞ ( \pm infinity ) when E = {2}^{15} - 2 \\ NaN ( q ) ( not a number ) when E = {2}^{15} - 1 s = 0 \\ NaN ( s ) ( not a number ) when E = {2}^{15} - 1 s = 1\end{matrix} \qquad ( 2 )$$

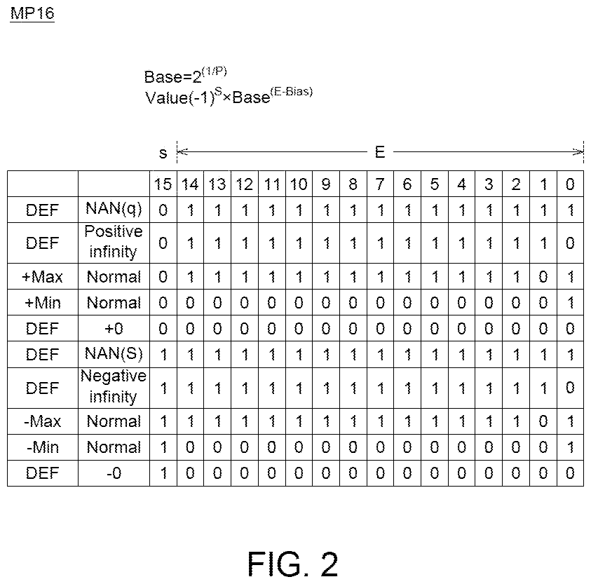

FIG. 2 illustrates some examples of the custom floating-point (MP16) format according to one embodiment of the present disclosure. In FIG. 2, the sign bit “s” of the sign field is displayed as bit 15, and the 15 exponent bits (e₁₄−e₀) of the exponent field are displayed as bits 14 to 0.

When s=0 and all exponent bits e₁₄-e₀ are 1 (i.e., when E=2\hat{ }15−1 and s=0), MP16 is NAN (q).

When s=1 and all exponent bits e₁₄-e₀ are 1 (i.e., when E=2\hat{ }15−1 and s=1), MP16 is NAN(s).

When s=0 and all exponent bits e₁₄-e₁ are 1, and e₀ is 0 (i.e., when E=2\hat{ }15−2 and s=0), MP16 represents positive infinity.

When s=1 and all exponent bits e₁₄-e₁ are 1, and e₀ is 0 (i.e., when E=2\hat{ }15−2 and s=1), MP16 represents negative infinity.

When s=0 and e₁₄-e₂ and e₀ are 1, while e₁ is 0 (i.e., when E=2\hat{ }15−3 and s=0), MP16 represents the positive maximum value of normal values (denoted as +Max).

When s=0 and e₁₄-e₁ are 0, and e₀ is 1 (i.e., when E=1 and s=0), MP16 represents the positive minimum value of normal values (denoted as +Min).

When s=1 and e₁₄-e₂ and e₀ are 1, while e₁ is 0 (i.e., when E=2\hat{ }15−3 and s=1), MP16 represents the negative maximum value of normal values (denoted as −Max).

When s=1 and e₁₄-e₁ are 0, and e₀ is 1 (i.e., when E=1 and s=1), MP16 represents the negative minimum value of normal values (denoted as −Min).

When s=0 and all exponent bits e₁₄-e₀ are 0 (i.e., when E=0 and s=0), MP16 is +0 (positive zero).

When s=1 and all exponent bits e₁₄-e₀ are 0 (i.e., when E=0 and s=1), MP16 is −0 (negative zero).

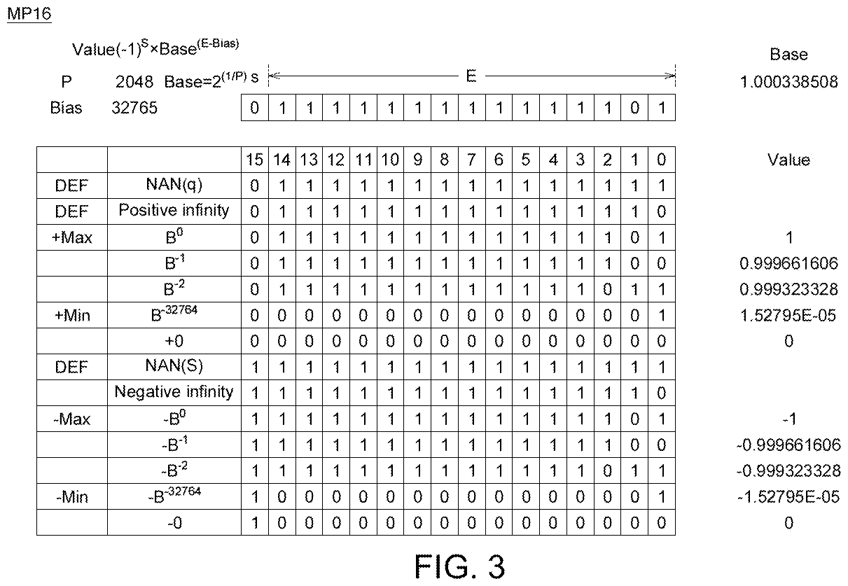

FIG. 3 presents a practical example of the custom floating-point (MP16) format according to one embodiment of the present disclosure. In this example, the setting of the base value is related to the parameter P, such as, but not limited to, Base=2\hat{ }(1/P). For instance, when P=2048, Base=2\hat{ }(1/2048)=1.000338508. Additionally, the bias value is set to Bias=32765.

In current AI computations, some custom floating-point formats often have insufficient numerical ranges, causing issues with direct usage. Therefore, scaling and bias techniques have been introduced to maximize the performance of custom floating-point number systems. However, these techniques also require additional information to effectively restore the recorded numbers. Thus, one embodiment of the application introduces “the bias value” to address this issue.

In the example shown in the third figure, the positive maximum value of normal values (+Max) is (−1)^{s}×Base^{(E-Bias)}=(−1)^{s}×Base⁽³²⁷⁶⁵⁻³²⁷⁶⁵⁾=Base⁰ (which is shown as B⁰)=1. The positive minimum value of normal values (+Min) is (−1)^{s}×Base^{(E-Bias)}=(−1)^{s}×Base⁽¹⁻³²⁷⁶⁵⁾=Base⁻³²⁷⁶⁴ (which is shown as B⁻³²⁷⁶⁴)=1.52795E−05.

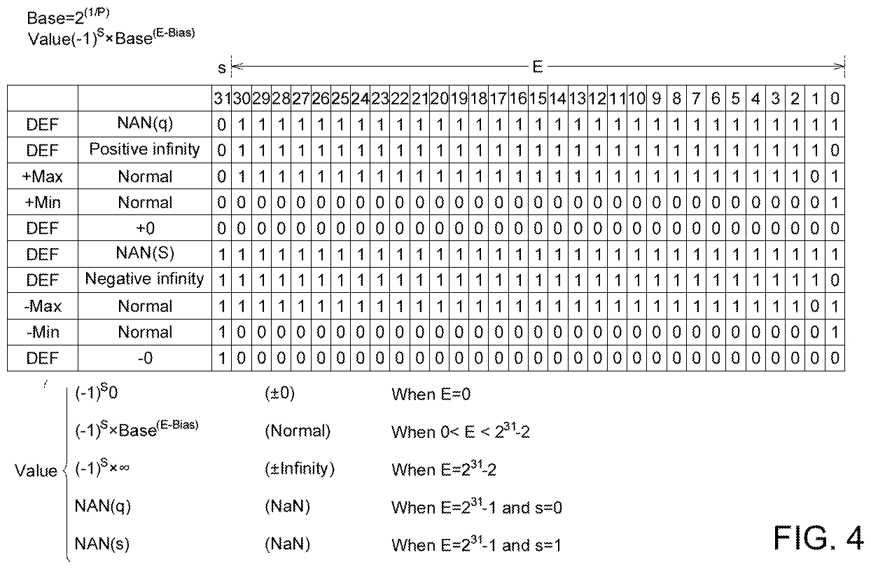

FIG. 4 illustrates the custom floating-point (MP) format according to one embodiment of the present disclosure. In this case, the example uses a 32-bit custom floating-point (MP) format, referred to as MP32, for explanation purposes. However, it is important to note that the present disclosure is not limited to this specific format.

The 32-bit custom floating-point (MP32) format comprises a sign field (including a 1-bit sign bit “s”) and an exponent field (including 31 bits denoted as e₃₀-e₀).

The representation of the 31 exponent bits in decimal as E (the numerical value of the exponent bits, also known as the value of the exponent field) is expressed by the following equation (3):

$$E = {\sum }_{0}^{30} {e}_{i} {2}^{i} ∈ [ 0 , {2}^{31} - 1 ] . \qquad ( 3 )$$

Therefore, the value of MP32 is as follows:

When E=0, MP32 is given by (−1)s·0. In this case, when s=0, MP32 is +0 (positive zero), and when s=1, MP32 is −0 (negative zero). Thus, when E=0, MP32 is referred to as positive-negative zero (±0), where E=0 indicates that all exponent bits in the exponent field are set to 0.

When 0<E<231−2, MP32 is given by MP32=(−1)^{s}×Base^{(E-Bias)}, referred to as a normal value.

When E=2\hat{ }31−2, MP32 is (−1)^{s}×∞, referred to as positive-negative infinity (±∞).

When E=2\hat{ }31−1 and s=0, MP32 is NAN (q).

When E=2\hat{ }31−1 and s=1, MP32 is NAN(s).

In summary:

Value=

$$\{ \begin{matrix}{( - 1 )}^{s} 0 ( \pm 0 ) when E = 0 \\ {( - 1 )}^{s} \times {Base}^{( E - Bias )} ( normla ) when 0 < E < {2}^{31} - 2 \\ {( - 1 )}^{s} ∞ ( \pm infinity ) when E = {2}^{31} - 2 \\ NaN ( q ) ( not a number ) when E = {2}^{31} - 1 s = 0 \\ NaN ( s ) ( not a number ) when E = {2}^{31} - 1 s = 1\end{matrix} \qquad ( 4 )$$

The above formula (4) would be expanded into following formula (5).

$$Value = \{ \begin{matrix}{( - 1 )}^{s} 0 ( \pm 0 ) when E = 0 \\ {( - 1 )}^{s} \times {Base}^{( E - Bias )} ( normal ) when 0 < E < {2}^{X} - 2 \\ {( - 1 )}^{s} ∞ ( \pm infinity ) when E = {2}^{X} - 2 \\ NaN ( q ) ( not a number ) when E = {2}^{X} - 1 s = 0 \\ NaN ( s ) ( not a number ) when E = {2}^{X} - 1 s = 1\end{matrix} \qquad ( 5 )$$

X represents the number of exponent bits in the exponent field, and X is a positive integer.

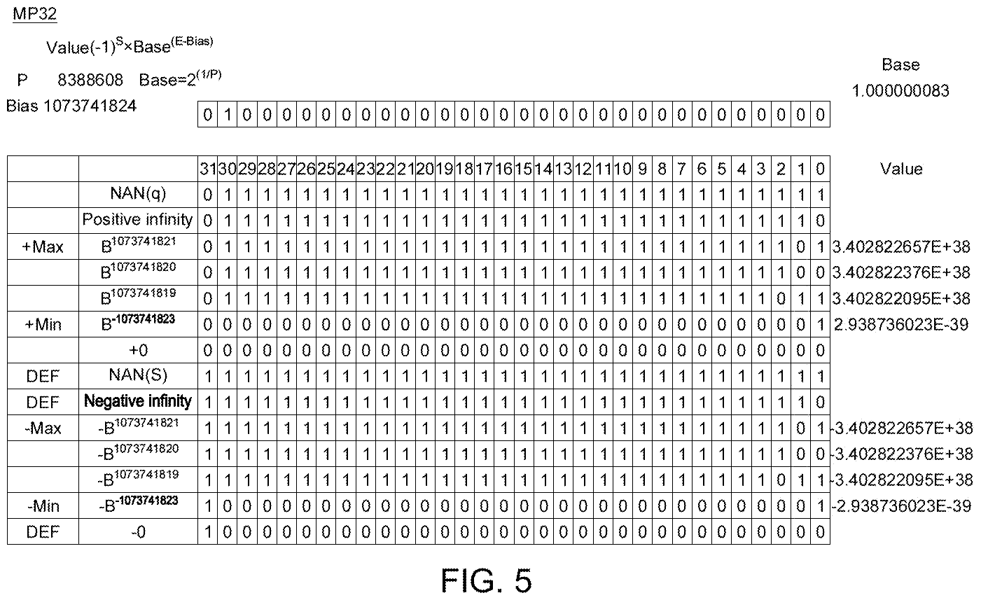

FIG. 5 illustrates some examples of the custom floating-point MP32 according to an embodiment of the present invention. In FIG. 5, the sign bit s of the sign field is shown as bit 31, and the 31 bits of the exponent bits e₃₀-e₀ in the exponent field are shown as bits 30 to 0.

When the sign bit s is 0 and all the exponent bits e₃₀-e₀ in the exponent field are 1 (i.e., when E=2\hat{ }31−1 and s=0), MP32 is NAN (q).

When the sign bit s is 1 and all the exponent bits e₃₀-e₀ in the exponent field are 1 (i.e., when E=2\hat{ }31−1 and s=1), MP32 is NAN(s).

When the sign bit s is 0 and all the exponent bits e₃₀-e₁ are 1, and the exponent bit e₀ is 0 (i.e., when E=2\hat{ }31−2 and s=0), MP32 is positive infinity.

When the sign bit s is 1 and all the exponent bits e₃₀-e₁ are 1, and the exponent bit e₀ is 0 (i.e., when E=2\hat{ }31−2 and s=1), MP32 is negative infinity.

When the sign bit s is 0 and the exponent bits e₃₀-e₂ and e₀ are 1, and the exponent bit e₁ is 0 (i.e., when E=2\hat{ }31−3 and s=0), MP32 is the positive maximum value of normal values (+Max).

When the sign bit s is 0 and the exponent bits e₃₀-e₁ are 0, and the exponent bit e₀ is 1 (i.e., when E=1 and s=0), MP32 is the positive minimum value of normal values (+Min).

When the sign bit s is 1 and the exponent bits e₃₀-e₂ and e₀ are 1, and the exponent bit e₁ is 0 (i.e., when E=2\hat{ }31−3 and s=1), MP32 is the negative maximum value of normal values (−Max).

When the sign bit s is 1 and the exponent bits e₃₀-e₁ are 0, and the exponent bit e₀ is 1 (i.e., when E=1 and s=1), MP32 is the negative minimum value of normal values (−Min).

When the sign bit s is 0 and all the exponent bits e₃₀-e₀ are 0 (i.e., when E=0 and s=0), MP32 is positive zero (+0).

When the sign bit s is 1 and all the exponent bits e₃₀-e₀ are 0 (i.e., when E=0 and s=1), MP32 is negative zero (−0).

In FIG. 5, the setting of the base value is related to the parameter P, such as, but not limited to, Base=2\hat{ }(1/P). For example, when P=8388608, then Base=2\hat{ }(1/2048)=1.000000083. In addition, the bias value Bias=1073741824.

Therefore, in the example shown in FIG. 5, the positive maximum value of normal values (+Max) is (−1)^{s}×Base^{(E-Bias)}=Base¹⁰⁷³⁷⁴¹⁸²¹ (which is shown as B¹⁰⁷³⁷⁴¹⁸²¹)=3.402822657E+38, and the positive minimum value of normal values (+Min) is (−1)^{s}×Base^{(E-Bias)}=Base⁻¹⁰⁷³⁷⁴¹⁸²³ (which is shown as B⁻¹⁰⁷³⁷⁴¹⁸²³)=2.938736023E−39.

From these examples, it can be seen that in an embodiment of the present invention, the value of the custom floating-point MP can be represented as (−1)^{s}×Base^{(E-Bias)}. Here, Base=2\hat{ }(1/P), 1<Base<2, and P is an integer greater than 1. E is the value of the exponent bits. In other embodiments of the application, P is a power of 2 (P=2\hat{ }n, n=1, 2, 3 . . . ). The bias value Bias is an integer greater than or equal to 1.

Taking the example of the known custom floating-point BF16, BF16 has 7 mantissa bits, so the linear coordinate between the values 1 and 2 is divided into 128 blocks (2\hat{ }7). Therefore, in an embodiment of the present invention, in order to set up an floating point number (MP) system with resolution similar to BF16, the values between 1 and 2 into are divided 128 blocks using logarithmic coordinates, so it chooses Base=2\hat{ }(1/P), P=128.

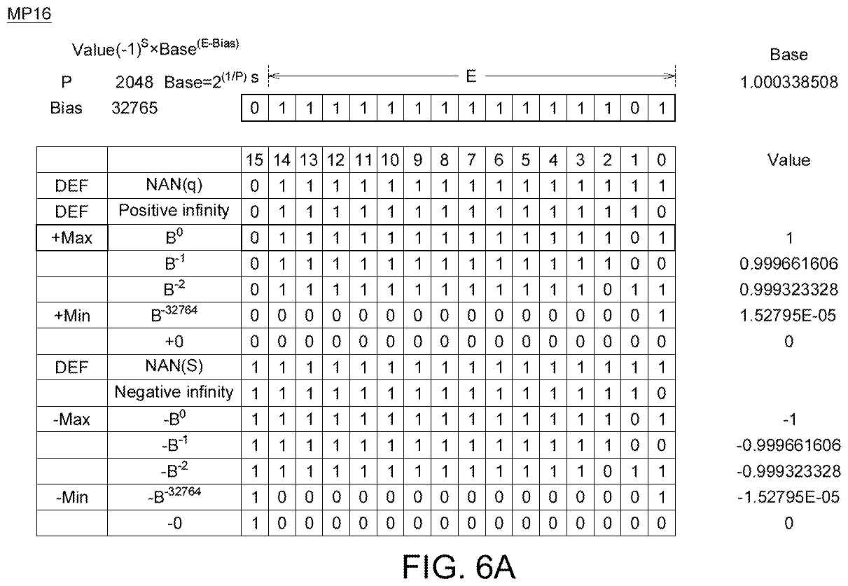

In this embodiment, the setting of the bias value Bias will be explained below. FIG. 6A and FIG. 6B illustrate how the bias value Bias is set in the floating-point number MP system of this embodiment.

In FIG. 6A, when the bias value Bias of MP16 is set to Bias=+Max (=B\hat{ }0=1), the positive maximum value of the floating-point number MP system is 1, which is a special setting. This is because in many existing databases, the maximum data value and the maximum calculation result are usually 1. Therefore, in this embodiment, by setting the bias value Bias to Bias=+Max, the positive maximum value of this value system is B\hat{ }0=1, and this setting can avoid wasting resources.

In FIG. 6B, when the bias value Bias of MP32 is set to Bias=01000000000000000000000000000000, in the floating-point number MP system, the space of values greater than 1 and the space of values less than 1 are basically the same, and this setting is similar to the system setting of the known custom floating-point FP32.

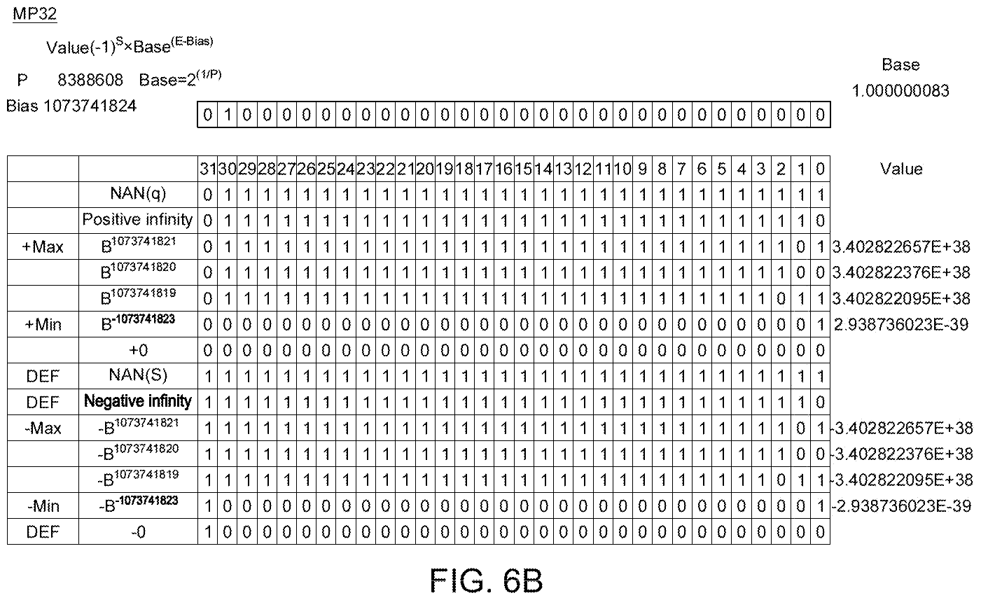

FIG. 7 illustrates the method of converting a floating-point number database according to an embodiment of the present disclosure, applied to an electronic device. FIG. 7 depicts the flowchart of converting an existing other floating-point database into a custom floating-point MP database of the present embodiment. In step 710, a plurality of test data are extracted from an existing other floating-point database (e.g., FP16 floating-point database), representing values in FP16 format; and.a test target is set.

In step 720, the value range of the existing other floating-point database is analyzed.

In step 730, parameters for the MP value format of the present embodiment are set based on the value range and computational requirements of the existing other floating-point database. These parameters may include, but are not limited to, bit size, base value, bias value, etc.

In step 740, the given test data from the existing other floating-point database is transformed into transformed data which has the MP value format of the present embodiment. The transformed data is then checked to see if the test target is achieved. If step 740 is true, the process proceeds to step 750. If step 740 is false, the process returns to step 730 to readjust the parameters of the MP value format.

In step 750, based on the parameters that can achieve the test target, the existing other floating-point database are converted into the custom floating-point MP database of the present embodiment. The values in this custom floating-point MP database adhere to the custom floating-point MP format of the present embodiment. For instance, converting an existing FP32floating-point database into a custom MP16 database can result in approximately half the size of the database and a corresponding reduction in data transmission requirements.

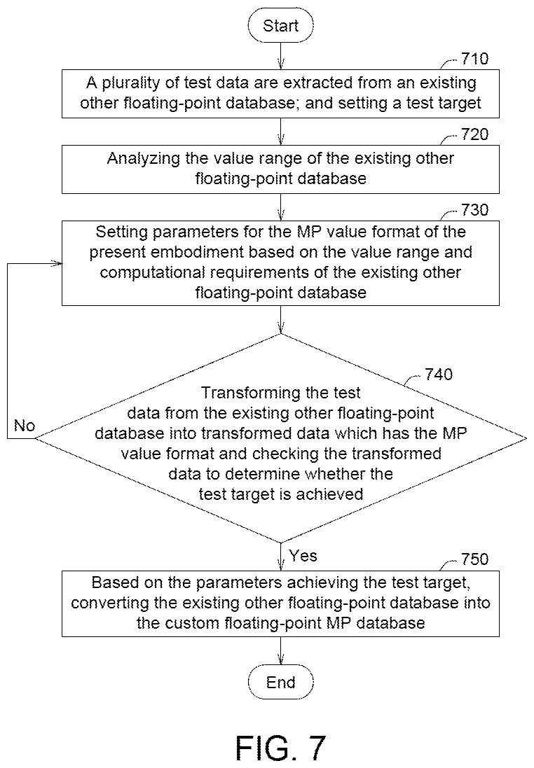

FIG. 8A and FIG. 8B figures depict MP data processing according to an embodiment of the present disclosure. In FIG. 8A, a database 810 sends custom floating-point MP data to a system 820, where the system 820 converts the custom floating-point MP data into non-MP floating-point data. This reduces the transmission requirements between the database 810 and the system 820.

In FIG. 8B, after the database 810 converts custom floating-point MP data into non-MP floating-point data, the non-MP floating-point data is sent to the system 820. This design helps reduce the processing burden on the system 820 when the floating-point conversion is handled by the database 810.

The floating-point conversion in FIGS. 8A and 8B can be done either in software or hardware, both falling within the scope of the present disclosure. The custom floating-point MP designed in accordance with an embodiment of the present disclosure discloses that the architecture of the MP multiplier may be relatively simple. Additionally, hardware chips optimized for the custom floating-point MP can be placed either inside system 820 or inside database 810, all within the scope of the present disclosure.

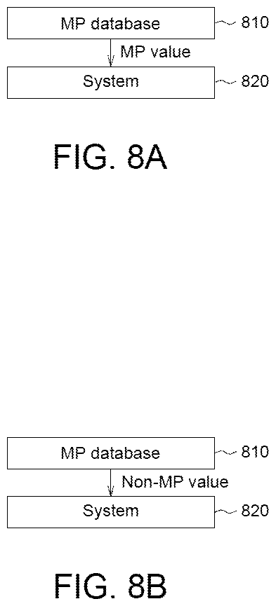

FIG. 9 illustrates a neural network training method according to an embodiment of the present disclosure, applied to an electronic device. In the training phase of the neural network (NN) model, custom floating-point MP is used. In step 910, multiple input data (in non-MP floating-point format, e.g., FP format) are received. In step 920, relevant parameters of the custom floating-point MP format of the present embodiment are set, such as base value, P value, bias value, bit size, etc.

In step 930, during the training process, the input data is converted into the custom floating-point MP format of the present embodiment. The weight values are trained using the custom floating-point MP format. In this process, the optimal parameters (such as base value, P value, bias value, bit size, etc.) for the custom floating-point MP format are found, ensuring that the trained weight values result in optimal performance for the neural network model.

In step 940, when the model training is complete, the optimized parameters of the custom floating-point MP format are stored.

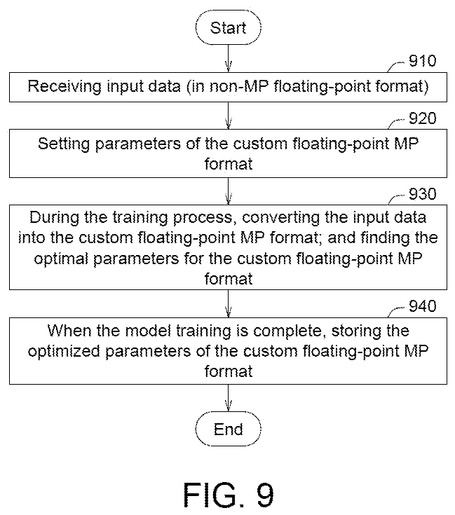

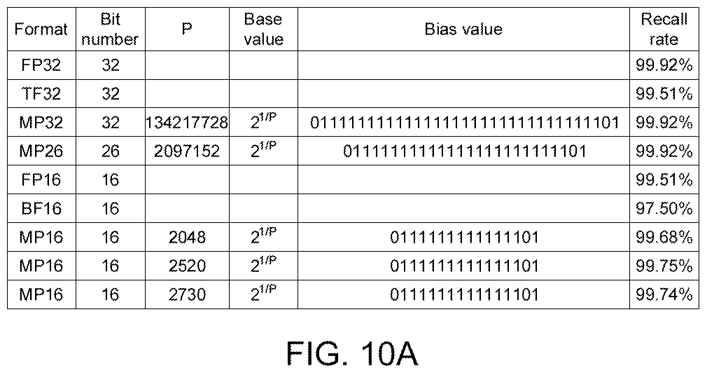

FIG. 10A presents experimental results comparing the custom floating-point MP format of an embodiment with other existing non-MP formats (such as FP32, TF32, FP16, BF16, etc.). The experiment involves converting an existing FP32 database into different 16-bit databases (FP16, BF16, MP16), then converting back to FP32 for comparison. The differences in scores essentially represent the loss incurred during the conversion process.

Using the Yandex DEEP database as an example, with 1 billion data points, each having a 96-dimensional vector in FP32 format, the test involves 10,000 test data points. The aim is to search and output the top ten vectors closest to the test vector in the 1 billion databases. The experiment examines which floating point numerical format achieves the desired results. The condition for success is a recall rate of 90%, meaning that among the returned 10,000 data points, there is an average accuracy of 90%.

In this experiment, the effect of floating-point format conversion on recall rate is investigated. The data in the Yandex DEEP database is initially in FP32 format and is converted into TF32, FP16, and BF16. When converting from FP32 to MP format, parameters such as base and bias values need to be declared. The base value is calculated using the parameter P, i.e., Base=2\hat{ }(1/P). Given the knowledge about the Yandex DEEP database, the maximum value of the custom floating-point MP is set to 1, and the bias value is determined accordingly.

The custom floating-point MP26 in the present embodiment may achieve the desired test targets with fewer bits. The MP16 format in the present embodiment has three settings, for example but not limited by, P=2048 (P=2\hat{ }11), P=2520 and P=2730, and all three MP16 formats meet the requirements, demonstrating the hardware optimization benefits of the present embodiment.

FIG. 10B compares the numerical range of the custom floating-point MP format of an embodiment with other known floating-point formats BF16 and FP16. BF16 format has 1 sign bit (S), 8 exponent bits (E), and 7 mantissa bits (M). FP16 format has 1 sign bit (S), 5 exponent bits (E), and 10 mantissa bits (M).

In FIG. 10B, the region 1000 represents the numerical range of the database, covering computational requirements. BF16 and FP16 formats have fixed settings for exponent and mantissa bits, which offer generality but lack optimization based on specific requirements. FP16 format doesn't meet the record requirements of the database, while BF16, although meeting the recording space requirement, has reduced resolution.

In contrast, the custom floating-point MP of the present embodiment allows optimization based on requirements. It allows the adjustment of base and/or bias values according to needs, enabling full utilization of the numerical range and optimization based on requirements.

In the present embodiment, the base value aligns with the full exponent requirements, i.e., 1<Base<2. This allows cutting between the values 1-2. The closer the value is to 1, the finer the cutting.

Additionally, how to select the base value also affects the evaluation of the numerical system. In the present embodiment, Base=2\hat{ }(1/P). P=2, 3, 4, . . . , where P is a positive integer greater than 1. Every doubling of the numerical space is divided into P equal parts, linearly cut on a logarithmic scale.

Furthermore, each doubling aligns automatically with the 1/2/4/8 . . . digits of the known FP system, bringing benefits such as (1) self-alignment of MP and FP systems at every doubling, reducing conversion issues between different formats, and (2) having a pattern, advantageous for hardware design. For optimization, a special design with P=2\hat{ }n (n is a positive integer greater than or equal to 1) is particularly considered.

As known, the traditional FP numerical system represents numbers in the format A*B\hat{ }n (B=2), where the coefficient A is linear in coordinates and linearly cut between 1 and 2 in 2\hat{ }M grids (M is the mantissa bits). However, this design makes it challenging for multiplier design with increasing resolution demands.

In contrast, for the custom floating-point MP format of the present embodiment, the numerical representation is (−1)^{s}×Base^{(E-Bias)}, Base=2^{(1/P)}. That is, in the present embodiment, the coefficient of Base^{(E-Bias)} is always 1, with carry-over beyond 1. Therefore, in the present embodiment, the logarithmic coordinates between 1-2 are cut into P grids. Thus, the custom floating-point MP format of the present embodiment is referred to as the full exponent format (as it only includes sign and exponent bits, excluding mantissa bits). This full exponent MP system is a novel format that breaks free from many restrictions of typical FP systems, providing flexibility for optimization.

Additionally, to ensure generality, the custom floating-point MP format of the present embodiment requires the declaration of base and bias values for accurate reading of the numerical value.

Therefore, the full exponent custom floating-point MP format of the present embodiment breaks free from the constraints of the known FP format (B=2), allowing a smaller base value (1<Base<2) to escape the limitation of drawing only one point in every doubling space. In other words, the exponent bits are responsible for both the range and resolution simultaneously. In contrast, in the known FP format, the exponent bits are responsible for the range, and the mantissa bits are responsible for the resolution.

The circuit area of the multiplier in the known FP format increases significantly with increasing resolution demands. In comparison, in the present embodiment, the hardware floating-point multiplier designed based on the MP format does not need to consider mantissa bits, resulting in a smaller circuit area. Additionally, in the present embodiment, the setting values of the base value (Base) and bias value (Bias) can be optimized according to requirements. Therefore, for the same bit size, the MP format multiplier of the present embodiment has better resolution, or, the MP format multiplier of the present embodiment can achieve the same resolution with fewer bits.

In the present embodiment, taking MP16 as an example, the base value Base is set to 1<Base<2, Base=2\hat{ }(1/P), where P is a positive integer greater than 1. Among them, when P is a power of 2 (P=2\hat{ }n, n=1, 2, 3 . . . ), it is a better setting. As for the bias value, it can be between 0111111111111101 and 000000000000000.

In summary, the advantages of the custom floating-point MP format in the present embodiment include, but are not limited to, (1) each floating-point number is (−1)^{s}×Base^{(E-Bias)}, which is advantageous for large matrix operations as multiplication becomes addition; (2) when performing addition of the same numeric value, a counter can be used for calculation, and B^{a}+B^{a}=2*B^{a}=B^{p}*B^{a}=B^{(a+p)}, and the Base^{(E-Bias)} term can be simplified during the multiplication and addition operations, making the computation straightforward until the final summation.

The present embodiment discloses a custom floating-point system where the bit representation of the floating-point format includes only sign and exponent bits, without mantissa bits, and where the base value is between 1 and 2. The floating-point format requires the declaration of base and bias values, and the base value is not an integer. In other embodiments of the present disclosure, Base=q\hat{ }(1/P), q=2, 3, 4, 5 . . . (q is a positive integer greater than 1), P=2, 3 . . . (P is a positive integer greater than 1), and when P is a power of 2 (P=2\hat{ }n, n=1, 2, 3 . . . ), it is a better setting. The exponent bits determine the numerical range and resolution of the floating-point number. In contrast, the traditional floating-point format only determines the numerical range with the exponent bits, and the resolution is determined by the mantissa bits.

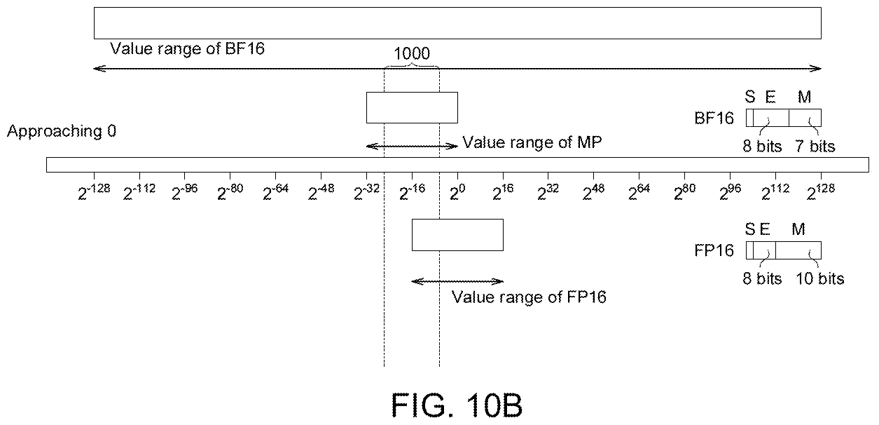

FIG. 11 illustrates an example of a neural network processing system 1100 according to an embodiment of the present disclosure. The neural network processing system 1100 is an example of a system implemented as a computer program on one or more computers located at one or more locations.

The neural network system 1100 includes one or more memory devices 1105, which store a neural network 1110. The neural network 1110 has one or more neural network models. When training one or more of the neural network models, the numbers stored in the memory devices 1105 can be in the custom floating-point MP format of the embodiments described herein. The input values, weight values, and output values of the neural network 1010 are represented in the custom floating-point MP format as described in the embodiments.

The neural network processing system 1100 is a processing system that uses floating-point arithmetic to perform neural network computations.

Floating-point arithmetic refers to performing calculations using floating-point data types. The neural network 1110 is an example of a neural network that can be configured to receive any type of digital data input and generate scores or classification outputs based on the digital data input.

The neural network 1110 includes multiple neural network layers, including one or more input layers, an output layer, and one or more hidden layers. Each neural network layer comprises one or more neural network nodes, and each node has one or more weight values. Each node processes a series of input values using its respective weight values and performs operations on the processing result to generate an output value.

In some implementations, each node of each input layer of the neural network 1110 receives a set of floating-point input values. The output value is the value generated by the output layer node of the neural network 1110 when processing the network input.

The neural network processing system 1100 can store the generated neural network output in an output data repository or provide the neural network output for other purposes, such as displaying on user devices or further processing by another system.

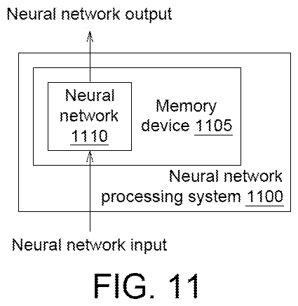

FIG. 12 provides a schematic diagram of a system architecture according to an embodiment of the present disclosure. The technical solution of the embodiments described herein can be implemented in the system architecture shown in FIG. 12 or a similar system architecture. As shown in FIG. 12, the system architecture may include multiple electronic devices, such as an electronic device 1210, an electronic device 1220, and an electronic device 1230, etc. Communication connections between electronic devices 1210, 1220, and 1230 can be established through wired or wireless networks (such as WiFi, Bluetooth, and mobile networks, etc.) to perform data storage, calculation, and transmission based on floating-point numbers in various fields (finance, engineering, scientific research, aerospace, etc.).

As shown in FIG. 12, taking the electronic device 1210 as an example, the electronic device 1210 may include a decoder 1211 and an encoder 1212 for floating-point processing, a memory 1213, and multiple computing units 1214 (such as computing unit 1, computing unit 2, computing unit 3, . . . , computing unit N, etc.). Specifically, when the electronic device 1210 performs general computing, high-performance computing, or AI training, a large amount of floating-point data may be required. In such cases, the electronic device 1210 can use the decoder 1211, based on the custom floating-point MP format provided in the embodiments, to obtain corresponding floating-point numbers (which can be obtained from the memory 1213 or from the electronic devices 1220 or 1230 via wired or wireless networks), and transmit the floating-point data to computing units to perform corresponding calculations. The results obtained by computing units can be encoded into floating-point numbers by the encoder 1212, which can be used for data storage and transfer. The embodiments described herein can flexibly meet different requirements for the numerical range and precision of floating-point numbers in various scenarios (such as general computing, high-performance computing, or AI training, etc.) without increasing the total number of bits, that is, without increasing the cost of data storage or data transfer.

Optionally, in FIG. 12, the structure and function of the electronic devices 1220 and 1230 can be similar to the electronic device 1210. In some possible implementations, the electronic devices 1210, 1220, and 1230 may include more or fewer components than shown in FIG. 12. The embodiments described herein do not specifically limit this.

In summary, the electronic devices 1210, 1220, and 1230 can be smart wearable devices, smartphones, smart home appliances, tablets, laptops, desktop computers, in-car computers, or servers with the functions described above. They can be a server, a server cluster composed of multiple servers, or a cloud computing service center, etc. The embodiments described herein do not specifically limit this.

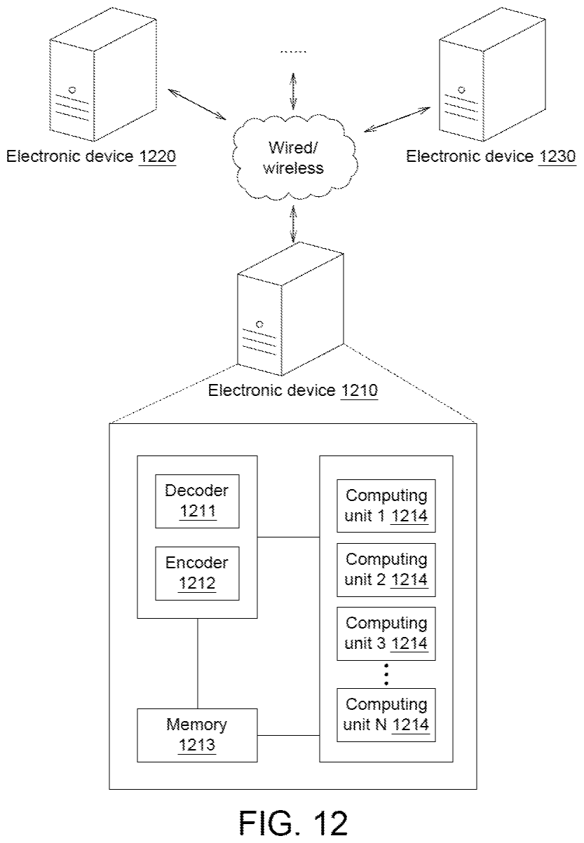

Based on the description of the method and device embodiments above, another embodiment also discloses an electronic device. FIG. 13 is a structural schematic diagram of an electronic device in an embodiment. As shown in FIG. 13, the electronic device 1300 includes at least a processor 1301, an input device 1302, an output device 1303, and a storage device 1306. The storage device 1306 includes a computer-readable storage medium 1304 and a database 1305. The electronic device 1300 may also include other common components, which are not detailed here. The processor 1301, input device 1302, output device 1303, and computer-readable storage medium 1304 in the electronic device 1300 can be connected by a bus or other means. The electronic device 1300 shown in the 13th figure can be used to implement the electronic devices 1210, 1220 and 1230 in FIG. 12.

The processor 1301 may be a general central processing unit (CPU), microprocessor, or application-specific integrated circuit (ASIC). The processor 1301 may be compatible with the custom floating-point MP format of the embodiments described herein. Additionally, the processor 1301 can be used to execute the floating-point processing method described in the embodiments.

The memory in the electronic device 1300 may be read-only memory (ROM) or other types of static storage devices that can store static information and instructions, random access memory (RAM) or other types of dynamic storage devices that can store information and instructions, electrically erasable programmable read-only memory (EEPROM), read-only optical discs (Compact Disc Read-Only Memory, CD-ROM) or other optical disc storage media, magnetic disc storage devices or other magnetic storage devices, or any other medium capable of carrying or storing code in the form of instructions or data structures and that can be accessed by a computer. The memory may exist independently or be connected to the processor by a bus. Memory may also be integrated with the processor.

The computer-readable storage medium 1304 can store computer programs containing program instructions. When the processor 1301 executes the program instructions stored in the computer-readable storage medium 1304, the processor 1301 can execute any portion or all of the steps described in any of the embodiments.

Another embodiment further discloses a computer-readable storage medium, wherein the computer-readable storage medium stores a program. When the program is executed by a processor, the processor can execute any portion or all of the steps described in any of the embodiments.

Still another embodiment also discloses a computer program, which includes instructions. When the computer program is executed by a multi-core processor, the processor can execute any portion or all of the steps described in any of the embodiments.

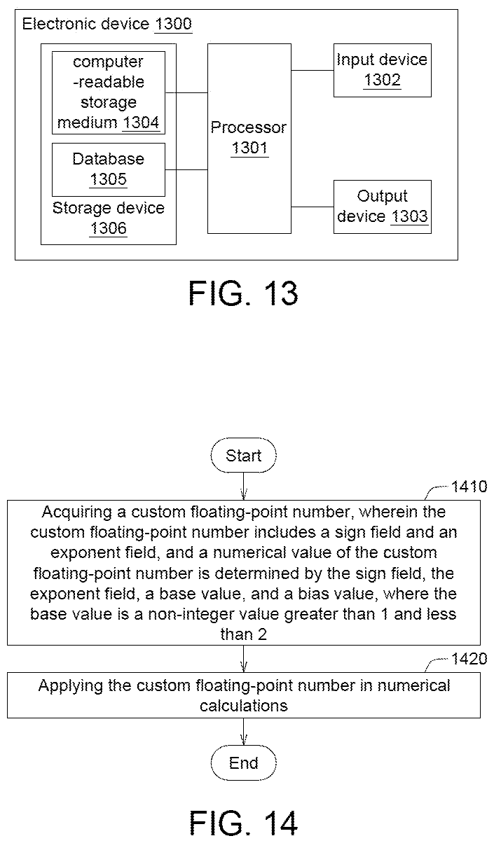

FIG. 14 illustrates a method for floating-point processing according to an embodiment, applied to an electronic device. The method for floating-point processing includes: (1410) acquiring a custom floating-point number, wherein the custom floating-point number includes a sign field and an exponent field, and a numerical value of the custom floating-point number is determined by the sign field, the exponent field, a base value, and a bias value, where the base value is a non-integer value greater than 1 and less than 2; and (1420) applying the custom floating-point number in numerical calculations.

Furthermore, in the floating-point system of the embodiments, when the bias value is equal to the positive maximum value of normal value, resource waste can be avoided.

In another embodiment, the custom floating-point MP format provided in the embodiments can be applied to a database (i.e., numerical values in the database are recorded in the custom floating-point MP format). Additionally, the custom floating-point MP format provided in the embodiments can be applied to in-memory computing. That is, when performing in-memory computing, the calculated numerical values can be in the custom floating-point MP format of the embodiments.

The custom floating-point MP format provided in the embodiments can be used in artificial intelligence model training (training weight values), achieving accelerated computation and reducing computation, storage, and transmission requirements.

The custom floating-point MP format provided in the embodiments can be used in edge devices, achieving accelerated computation and reducing computation, storage, and transmission requirements.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method for processing floating-point numbers applied to an electronic device, the method comprising:
acquiring a custom floating-point number, wherein the custom floating-point number includes a sign field and an exponent field, and a numerical value of the custom floating-point number is determined by the sign field, the exponent field, a base value, and a bias value, where the base value is a non-integer value greater than 1 and less than 2; and
applying the custom floating-point number in numerical calculations.

2. The method for processing floating-point numbers according to claim 1, wherein:
the exponent field includes X exponent bits, where X is a positive integer;
when an exponent value E of one exponent field is 0, the numerical value of the custom floating-point number is positive or negative 0;
when the exponent value E of the exponent field is greater than 0 and less than 2\hat{ }X−2, the numerical value of the custom floating-point number is: (−1)^{s}×Base^{(E-Bias)}, where the numerical value of the custom floating-point number is a normal value, where Base is the base value, Bias is the bias value, and s represents the sign bit of the sign field;
when E=2\hat{ }X−2, the numerical value of the custom floating-point number is positive or negative infinity; and
when E=2\hat{ }X−1, the numerical value of the custom floating-point number is not a number.

3. The method for processing floating-point numbers according to claim 1, wherein the bias value is a positive integer greater than or equal to 1.

4. The method for processing floating-point numbers according to claim 1, wherein the base value Base is represented as: Base=q\hat{ }(1/P), where parameters q and P are positive integers greater than 1.

5. The method for processing floating-point numbers according to claim 4, wherein the parameter P is an exponent of 2, P=2\hat{ }n, where n is a positive integer.

6. The method for processing floating-point numbers according to claim 1, wherein the exponent field determines a numerical value range and a resolution of the numerical value of the custom floating-point number.

7. The method for processing floating-point numbers according to claim 1, wherein when the bias value is set to a positive maximum value of a normal value, a maximum value of the numerical value of the custom floating-point number is 1.

8. A floating-point processing device comprising a processor, the processor performing:
acquiring a custom floating-point number, wherein the custom floating-point number includes a sign field and an exponent field, and a numerical value of the custom floating-point number is determined by the sign field, the exponent field, a base value, and a bias value, where the base value is a non-integer value greater than 1 and less than 2; and
applying the custom floating-point number in numerical calculations.

9. The device for processing floating-point numbers according to claim 8, wherein:
the exponent field includes X exponent bits, where X is a positive integer;
when an exponent value E of one exponent field is 0, the numerical value of the custom floating-point number is positive or negative 0;
when the exponent value E of the exponent field is greater than 0 and less than 2\hat{ }X−2, the numerical value of the custom floating-point number is: (−1)^{s}×Base^{(E-Bias)}, where the numerical value of the custom floating-point number is a normal value, where Base is the base value, Bias is the bias value, and s represents the sign bit of the sign field;
when E=2\hat{ }X−2, the numerical value of the custom floating-point number is positive or negative infinity; and
when E=2\hat{ }X−1, the numerical value of the custom floating-point number is not a number.

10. The device for processing floating-point numbers according to claim 8, wherein the bias value is a positive integer greater than or equal to 1.

11. The device for processing floating-point numbers according to claim 8, wherein the base value Base is represented as: Base=q\hat{ }(1/P), where parameters q and P are positive integers greater than 1.

12. The device for processing floating-point numbers according to claim 11, wherein the parameter P is an exponent of 2, P=2\hat{ }n, where n is a positive integer.

13. The device for processing floating-point numbers according to claim 8, wherein the exponent field determines a numerical value range and a resolution of the numerical value of the custom floating-point number.

14. The device for processing floating-point numbers according to claim 8, wherein when the bias value is set to a positive maximum value of a normal value, a maximum value of the numerical value of the custom floating-point number is 1.

15. A method for converting a floating-point database applied to an electronic device, the floating-point database conversion method comprising:
extracting a plurality of test data from a first floating-point database and setting a test target, where values in the first floating-point database are in a first floating-point format;
analyzing a numerical value range of the first floating-point database;
based on the numerical value range of the first floating-point database and a calculation requirement, setting a plurality of parameters for a second floating-point format;
converting the plurality of test data in the first floating-point format into a plurality of converted data in the second floating-point format, and checking whether the test target is achieved; and
when the test target is achieved, converting the first floating-point database into a second floating-point database based on the plurality of parameters of the second floating-point format, where values in the second floating-point database are in the second floating-point format.

16. The floating-point database conversion method according to claim 15, wherein the second floating-point format is a format of the custom floating-point number according to claim 1.

17. A neural network training method applied to an electronic device, the neural network training method comprising:
receiving a plurality of input data;
setting a plurality of parameters of a custom floating-point number format; and
converting the input data into a plurality of converted data in accordance with the custom floating-point number format, and training a plurality of weight values, where the weight values conform to the custom floating-point number format, to find and store optimized parameters of the custom floating-point number format.

18. The neural network training method according to claim 17, wherein the custom floating-point number format is a format of the custom floating-point number according to claim 1.
